(19) United States
(12) Patent Application Publication
(10) Pub. No.: US 2003/0223380 A1
(43) Pub. Date: Dec. 4, 2003

(54) Ring network system

(75) Inventors: Hideyuki Asakawa, Tokyo (JP); Noriyuki Amano, Miyagi (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/442,274

(22) Filed: May 21, 2003

(30) Foreign Application Priority Data
May 31, 2002 (JP) 160836/2002

(51) Int. Cl. H04L 12/28

(52) U.S. Cl. 370/258

(57) ABSTRACT

The present invention reduces the number of optical fibers used without impairing a self-recovery function of a ring network system. Current interfaces of a plurality of nodes constituting a ring network system are connected together by optical fibers, while standby interfaces of the nodes are connected together by optical fibers. However, an optical fiber is connected to an input end and an output end of each of those current interfaces which are not involved in signal communication in the current interfaces, in such a manner that the optical fiber loops from the input end to the output end.

### BACKGROUND OF THE INVENTION

1. Field of the Invention

The present invention relates to a ring network system, and more specifically, to a network system comprising a plurality of nodes each having a line protection function and connected together via a transmission path such as optical fibers.

2. Description of the Related Art

A BLSR (Bidirectional Line Switched Ring) network system of the SONET (Synchronous Optical NETwork) commonly comprises a plurality of nodes connected together in ring form using optical fibers. Each node has a current interface (active interface) and a standby interface. The two adjacent nodes are connected together by connecting the current interface of one of the nodes and the current interface of the other node together by an optical fiber and connecting the standby interface of one of the nodes and the standby interface of the other node together by an optical fiber. Data transfer is normally carried out using the current interfaces and the optical fiber. However, if any fault occurs in the current transmission path, the path is automatically switched inside the corresponding node. The current transmission path is interrupted in the corresponding section and automatically switched to the standby transmission path. In this manner, this fault is avoided.

The details of the BLSR system is described in the document “SONET Bidirectional Line-Switched Ring Equipment Generic Criteria”, Bellcore, Generic Requirements GR-1230-CORE Issue, December, 1998).

In the BLSR network system, in general, the current interfaces of the adjacent nodes are connected together by the optical fiber, while the standby interfaces of the adjacent nodes are connected together by the optical fiber. This connecting operation is performed without considering whether or not signals can be communicated to the current interface of each node. Thus, disadvantageously, those sections of the current optical fiber in which signals are not communicated do not contribute to any signal transmitting operations but this optical fiber still requires laying work and maintenance operations.

### SUMMARY OF THE INVENTION

It is thus an object of the present invention to provide a ring network system that enables the number of optical fibers used to be reduced without impairing a self-recovery function of the ring network system.

It is another object of the present invention to provide a ring network system that enables the number of optical fibers used to be minimized without impairing the self-recovery function of the ring network system.

Other objections of the present invention which are not specified herein will be apparent from the description below and the accompanying drawings.

According to the present invention, a ring network system comprising a plurality of nodes each having a current interface and a standby interface and connected together via an optical transmission path, the system comprising an automatic recovery function,

wherein some of the current interfaces of the plurality of nodes are not involved in signal communication, and an optical waveguide is connected to an input end and an output end of each of the current interfaces that are not involved in signal communication.

In the ring network system of the present invention, some of the current interfaces of the nodes are not involved in signal communication, and the optical waveguide (optical fiber) is connected to the input end and output end of each of the current interfaces that are not involved in signal communication, in such a manner that the optical fiber loops from the input end to the output end. Thus, these current interfaces do not require any fiber laying or maintenance operations. This serves to reduce the number of optical fibers used in the network system. Therefore, the number of optical fibers used can be minimized by connecting the optical fiber to each of the current interfaces that are not involved in signal communication.

Further, the current interfaces to each of which the optical fiber is connected in a loop-back manner are not involved in signal communication in the system. This avoids impairing the self-recovery function of the ring network system.

Furthermore, the optical fiber is connected to the input end and output end of each of the current interfaces that are not involved in signal communication, in such a manner that the optical fiber loops from the input end to the output end. This prevents the issuance of an unwanted warning resulting from the determination that optical signals are interrupted.

In a preferred example of ring network system of the present invention, the plurality of nodes are linearly connected together at least via the standby interfaces of the nodes to form a node row, and the standby interfaces of the nodes located at opposite ends of the node row are connected together by an optical waveguide.

In another preferred example of ring network system of the present invention, the plurality of nodes are linearly connected together via the current and standby interfaces of the nodes to form a node row, and the standby interfaces of the nodes located at opposite ends of the node row are connected together by an optical waveguide.

### BRIEF DESCRIPTION OF THE DRAWINGS

FIG. 1 is a diagram schematically showing a configuration of a ring network system according to a first embodiment of the present invention;

FIG. 2 is a diagram illustrating operations of the ring network system according to the first embodiment of the present invention;

FIG. 3 is a diagram illustrating operations of the ring network system according to the first embodiment of the present invention;

FIG. 4 is a diagram illustrating how a bypass is generated when a fault occurs in both current and standby transmission lines in the ring network system according to the first embodiment of the present embodiment; and

FIG. 5 is a diagram schematically showing a configuration of a ring network system according to a second embodiment of the present invention.

### DETAILED DESCRIPTION OF THE PREFERRED EMBODIMENTS

Preferred embodiments of the present invention will be described below in detail with reference to the accompanying drawings.

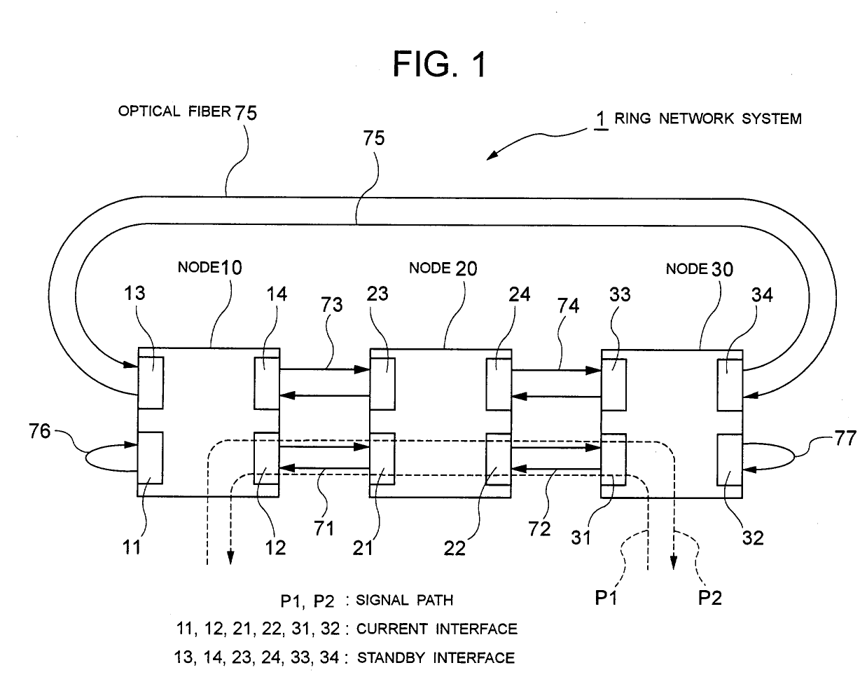

FIG. 1 is a diagram showing a ring network system according to a first embodiment of the present invention. This system comprises an automatic recovery function.

In FIG. 1, a ring network system 1 according to the first embodiment has three nodes 10, 20, and 30 each having a line protection function.

The node 10 has current interfaces 11 and 12 and standby interfaces 13 and 14. Each of the interfaces 11, 12, 13, and 14 has an input and output ends to each of which an end of an optical fiber is connected.

The node 20 has current interfaces 21 and 22 and standby interfaces 23 and 24. Each of the interfaces 21, 22, 23, and 24 has an input and output ends to each of which an end of an optical fiber is connected.

The node 30 has current interfaces 31 and 32 and standby interfaces 33 and 34. Each of the interfaces 31, 32, 33, and 34 has an input and output ends to each of which an end of an optical fiber is connected.

The current interface 11 of the node 10 is not connected to any other nodes. In other words, the interface 11 is not involved in the generation of a signal path P1 or P2 and is unused. Thus, the opposite ends of a single optical fiber 76 are connected to the input and output ends, respectively, of the interface 11. That is, as shown in FIG. 1, the single optical fiber 76 is connected to the input and output ends so as to loop between these ends.

The current interface 12 of the node 10 is connected to the current interface 21 of the adjacent node 20 by two optical fibers 71.

The standby interface 13 of the node 10 is connected to the standby interface 34 of the node 30 by two optical fibers 75. The standby interface 14 of the node 10 is connected to the standby interface 23 of the adjacent node 20 by two optical fibers 73.

The current interface 22 of the node 20 is connected to the current interface 31 of the adjacent node 30 by two optical fibers 72. The standby interface 24 of the node 20 is connected to the standby interface 33 of the node 30 by two optical fibers 74.

The current interface 32 of the node 30 is not connected to any other nodes as in the case with the current interface 11 of the node 10. In other words, the interface 32 is not involved in the generation of a signal path P1 or P2 and is unused. Thus, the opposite ends of a single optical fiber 77 are connected to the input and output ends, respectively, of the interface 32. That is, as shown in FIG. 1, the single optical fiber 77 is connected to the input and output ends so as to loop between these ends.

Each of the nodes 10, 20, and 30 has a function (line protection function) of internally switching the path to switch a signal path from current side to standby side when a fault is detected.

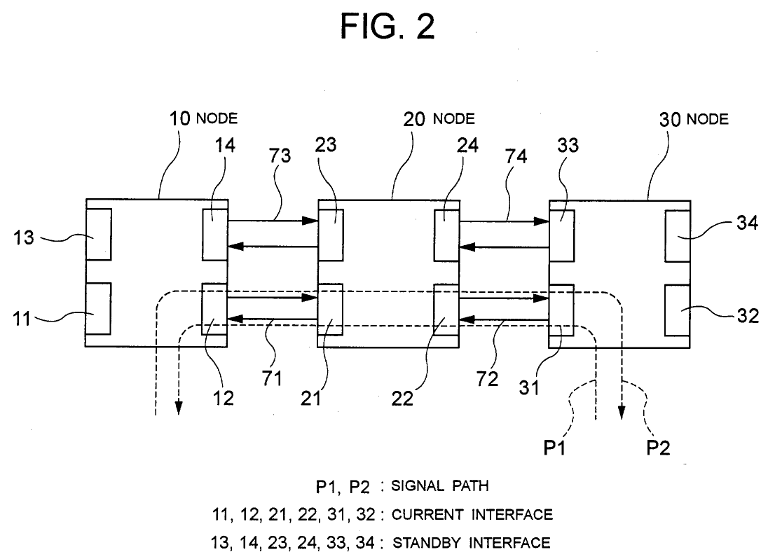

Now, with reference to FIGS. 2 to 4, description will be given to operations of the ring network system 1 of the first embodiment configured as described above.

The network system in FIG. 2 is composed of the three nodes 10, 20, and 30, extracted from the system 1 in FIG. 1. In this system, it is assumed that the signal paths P1 and P2 are generated via the current transmission path, i.e. the current interfaces 12, 21, 22, and 31 of the nodes 10, 20, and 30 and the optical fibers 71 and 72 as shown in FIG. 2. In this condition, the standby transmission path is unused.

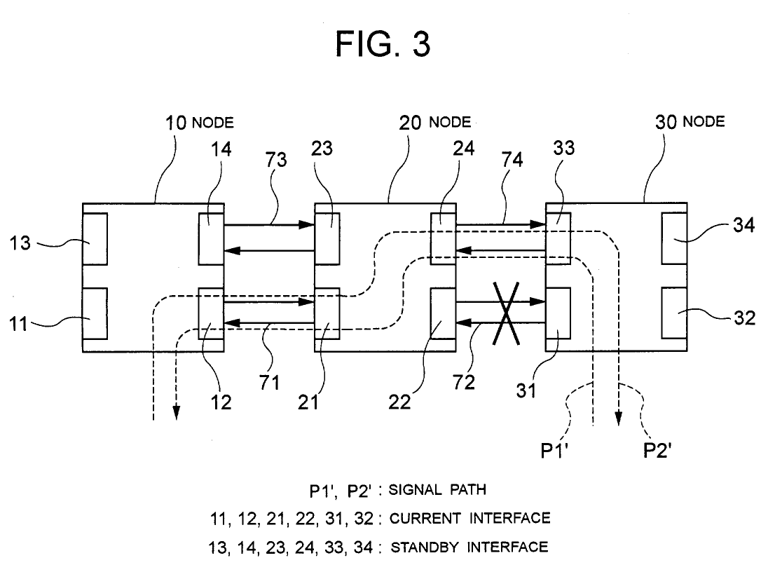

Then, it is assumed that any fault occurs in the current optical fiber 72 (or the interface 22 or 31 of the node 20 or 30, respectively) in the section between the nodes 20 and 30 as shown in FIG. 3. Then, the nodes 20 and 30 immediately detect a fault to internally switch the path to disable the current interfaces 22 and 31, while enabling the standby interfaces 24 and 33. Thus, if any fault occurs, signal paths P1′ and P2′ are newly generated using the current interface 21 and standby interface 24 of the node 20 and the standby interface 33 of the node 30 as shown in FIG. 3. This helps protect data or packets that have been flowing through the signal paths P1 and P2.

However, if any fault occurs in both current optical fiber 72 and standby optical fiber 74 (or the interfaces 22, 31, 24, and 33 of the nodes 20 and 30) in the section between the nodes 20 and 30, then the configuration in FIG. 3 cannot protect the data or packets that have been flowing through the signal paths P1 and P2. This is because the transmission path cannot be switched, in other words, there are no paths to which the defective path is switched. However, even in this case, the system 1, shown in FIG. 1, protects the data or packets that have been flowing through the signal paths P1 and P2, in the following manner.

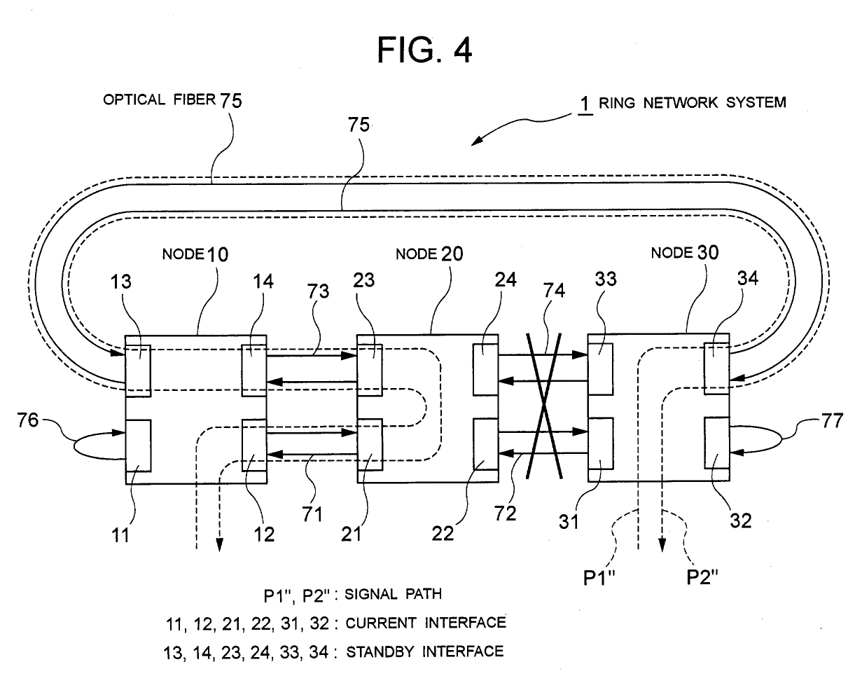

That is, if any fault occurs in both current and standby lines in the section between the nodes 20 and 30, the nodes 20 and 30 immediately detect this fault. Then, as shown in FIG. 4, the node 20 internally connects the current interface 21 and the standby interface 23 together. Accordingly, signal paths P1″ and P2″ are newly generated via the current interface 12 of the node 10, the optical fibers 73, the standby interfaces 14 and 13 of the node 10, the optical fibers 75, and the standby interface 34 of the node 30. That is, the signal paths P1″ and P2″ are generated as a bypass. This helps protect the data or packets that have been flowing through the signal paths P1 and P2. This is the original operation of the BLSR network system.

In this case, clearly, the current interface 11 of the node 10 and the current interface 32 of the node 30 are not involved in the operation of the system 1. Thus, the operation of the system 1 is not affected even if the optical fiber 76 is connected to the current interface 11 so as to loop from the interface 11 back to the interface 11.

Likewise, the operation of the system 1 is not affected even if the optical fiber 77 is connected to the current interface 32 so as to loop from the interface 32 back to the interface 32.

Accordingly, the number of optical fibers used can be reduced without impairing the self-recovery function of the ring network system 1. This means that the number of optical fibers used can be minimized without impairing the self-recovery function.

The optical fibers 76 and 77 are connected to the current interfaces 11 and 32, respectively, in a loop-back manner because if the optical fibers are not connected, the current interfaces 11 and 32 determine that optical signals are interrupted to issue an unwanted warning.

The optical fibers 76 and 77 connected to the current interfaces 11 and 32, respectively, in a loop-back manner have arbitrary lengths. It is sufficient to connect the optical fibers in a loop-back manner.

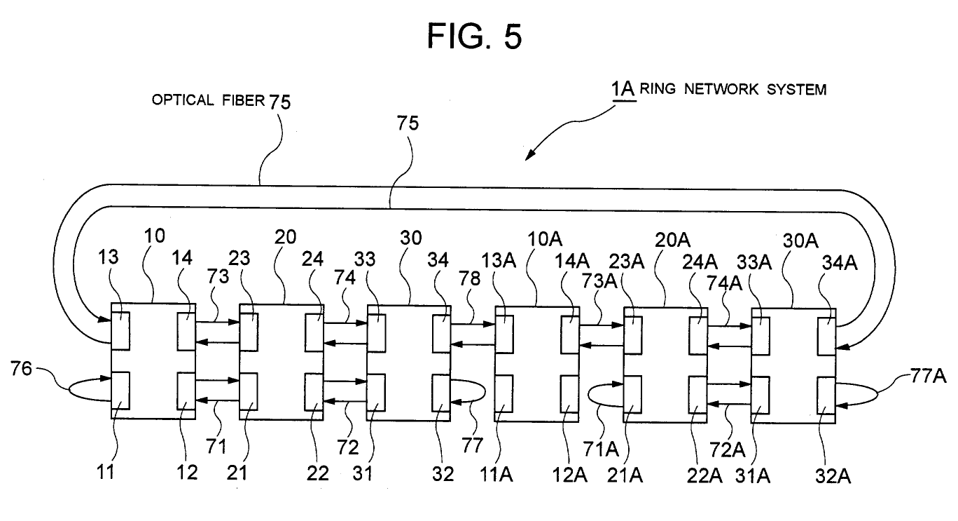

FIG. 5 is a diagram showing a ring network system 1A according to a second embodiment of the present invention. The configuration of the system 1A according to the second embodiment is substantially the same as that of the system 1 according to the first embodiment, shown in FIG. 1, except that the number of nodes is increased to six.

That is, the configuration of the nodes 10, 20, and 30 is the same as that in the first embodiment. Accordingly, they are denoted by the same reference numerals as those in the first embodiment. Their description is thus omitted.

A node 10A has current interfaces 11A and 12A and standby interfaces 13A and 14A. Each of the interfaces 11A, 12A, 13A, and 14A has an input end and an output end to which an end of an optical fiber is connected.

A node 20A has current interfaces 21A and 22A and standby interfaces 23A and 24A. Each of the interfaces 21A, 22A, 23A, and 24A has an input end and an output end to which an end of an optical fiber is connected.

A node 30A has current interfaces 31A and 32A and standby interfaces 33A and 34A. Each of the interfaces 31A, 32A, 33A, and 34A has an input end and an output end to which an end of an optical fiber is connected.

The current interfaces 11A and 12A of the node 10A are not connected to any other nodes. That is, the interfaces 11A and 12A are unused. No optical fibers are connected to the interface 11A or 12A.

The standby interface 13A of the node 10A is connected to the standby interface 34 of the node 30 by two optical fibers 78. The standby interface 14A of the node 10A is connected to the standby interface 23A of the adjacent node 20A by two optical fibers 73A.

The current interface 21A of the node 20A is not connected to any other nodes, as in the case with the current interface 11 of the node 10. In other words, the interface 21A is not involved in the generation of the signal path P1 or P2 and is unused. Thus, a single optical fiber 71A is connected to the interface 21A so as to loop from the interface 21A back to the interface 21A.

The current interface 22A of the node 20A is connected to the current interface 31A of the adjacent node 30A by two optical fibers 72A. The standby interface 24A of the node 20A is connected to the standby interface 33A of the node 30A by two optical fibers 74A.

The current interface 32A of the node 30A is not connected to any other nodes as in the case with the current interface 11 of the node 10 and is thus unused. A single optical fiber 77A is connected to the interface 32A so as to loop from the interface 32A back to the interface 32A.

The standby interface 34A of the node 30A is connected to the standby interface 13 of the node 10 by two optical fibers 75.

In addition to the nodes 10, 20, and 30, each of the nodes 10A, 20A, and 30A has the line protection function.

Next, the operation of ring network system 1A of the second embodiment configured as described above is substantially the same as that of ring network system 1 of the first embodiment. The system 1A can avoid both a possible fault between the nodes 10 and 30 and a possible fault between the nodes 20A and 30A.

In the above described first and second embodiments, three or seven nodes are connected together. However, in the present invention, the number of nodes connected together is arbitrary as long as it is two or more. Further, the connection between the nodes is not limited to the optical fibers. Other arbitrary optical waveguides may be used as long as they enable optical signals to be transmitted through themselves.

The present invention is preferably applied to the above described BLSR network system but is not limited to this aspect. The present invention is applicable to other similar systems with a plurality of nodes connected together in ring form.

As described above, according to the ring network system of the present invention, the number of optical fibers used can be reduced without impairing the self-recovery function of the ring network system. Further, the number of optical fibers used can be minimized by connecting the optical fiber to each of the current interfaces that are not involved in signal communication, in such a manner that the optical fiber loops from the current interface back to the same interface.

What is claimed is:

1. A ring network system comprising a plurality of nodes each having a current interface and a standby interface and connected together via an optical transmission path, the system comprising an automatic recovery function,
wherein some of the current interfaces of said plurality of nodes are not involved in signal communication, and an optical waveguide is connected to an input end and an output end of each of the current interfaces that are not involved in signal communication.

2. The ring network system according to claim 1, wherein said plurality of nodes are linearly connected together at least via the standby interfaces of the nodes to form a node row, and the standby interfaces of the nodes located at opposite ends of the node row are connected together by an optical waveguide.

3. The ring network system according to claim 1, wherein said plurality of nodes are linearly connected together via the current and standby interfaces of the nodes to form a node row, and the standby interfaces of the nodes located at opposite ends of the node row are connected together by an optical waveguide.

4. The ring network system according to claim 1, wherein the optical waveguide is an optical fiber.
